(19) United States
(12) Patent Application Publication
(10) Pub. No.: US 2026/0119850 A1
(43) Pub. Date: Apr. 30, 2026

(54) ARTIFICIAL INTELLIGENCE (AI) JUDGE SYSTEMS EMPLOYING SEARCH-DRIVEN CONSTITUTION-BASED FRAMEWORK, AND APPARATUSES, METHODS, AND NON-TRANSITORY COMPUTER-READABLE STORAGE MEDIA THEREFOR

(71) Applicant: HUAWEI TECHNOLOGIES CO., LTD., Shenzhen (CN)

(72) Inventors: Jia-Huei Lin, Kingston (CA); Dayl Lin, Toronto, CA (US); Zi Xuan Zhang, Kingston (CA); Ahmed E. Hassan, Kingston (CA)

(21) Appl. No.: 19/330,160

(22) Filed: Sep. 16, 2025

Related U.S. Application Data
(60) Provisional application No. 63/714,379, filed on Oct. 31, 2024.

(51) Int. Cl. G06N 3/0475

(52) U.S. Cl. CPC G06N 3/0475

(57) ABSTRACT

A computerized method for judging a foundation model (FM) powered software. The computerized method has the steps of: searching for a plurality of AI-judge components; constructing one or more AI-judge architectures based on the plurality of AI-judge components and a first constitution, the first constitution comprising one or more first principles each representing a requirement or rule adapted to a context related to the FMware; and executing the one or more AI-judge architectures to generate judgments for judging the FM-powered software.

### CROSS-REFERENCE TO RELATED APPLICATION

This application claims the benefit of U.S. Provisional Patent Application Ser. No. 63/714,379, filed Oct. 31, 2024, the content of which is incorporated herein by reference in its entirety.

### FIELD OF THE DISCLOSURE

The present disclosure relates generally to artificial intelligence (AI) judge systems, and apparatuses, methods, and computer-readable storage media therefor, and in particular to AI-judge systems employing search-driven constitution-based framework, and apparatuses, methods, and non-transitory computer-readable storage media therefor.

### BACKGROUND

Foundation models (FMs) or language models (LMs) such as large language models (LLMs) are neural network models that may learn the semantics and syntax of language by encoding (sub)words into vector representations. Foundation models have been used in various artificial intelligence (AI) applications such as generative AI systems.

The rapid rise of FM-powered software (also denoted “FMware”) has led to a growing need for robust evaluation mechanisms. However, given the open-ended nature of these responses of FMs that are part of an FMware, it is difficult for developers to either manually evaluate all the responses, or craft a test dataset that includes all the possible responses of an FMware as oracles, and use the test dataset to measure the quality of the FMware. Therefore, practitioners have been developing FM-based evaluators (also denoted “AI judges”) to reduce the manual evaluation effort for these FMware.

Developing AI-judge systems for the automatic evaluation of FMware offers several advantages. First, AI judges have shown to be capable of evaluating open-ended responses and can generate detailed explanations for their judgments. As the FMs in AI judges were trained on vast corpora, these models possess expertise in natural language understanding and instruction following, allowing them to measure various aspects of text quality effectively. Second, compared to human evaluators, AI judges require significantly less time for evaluations, enabling the evaluation of a large amount of data quickly. Additionally, AI judges are not affected by factors that are associated with human annotators (for example, fatigue, emotions, distractions, and/or the like).

### SUMMARY

According to one aspect of this disclosure, there is provided a computerized method for judging a foundation model (FM) powered software, the method comprising: searching for a plurality of AI-judge components; constructing one or more AI-judge architectures based on the plurality of AI-judge components and a first constitution, the first constitution comprising one or more first principles each representing a requirement or rule adapted to a context related to the FMware; and executing the one or more AI-judge architectures to generate judgments for judging the FM-powered software.

In some embodiments, the plurality of AI-judge components comprise: cognitive architectures, and jury FMs and their interactions.

In some embodiments, the computerized method further comprises: reconstructing at least one of the one or more AI-judge architectures based on the plurality of AI-judge components, the first constitution, and the judgments of the one or more AI-judge architectures.

In some embodiments, the computerized method further comprises: determining that the judgment of at least one AI-judge architecture of the one or more AI-judge architectures is inaccurate; and reconstructing the determined at least one AI-judge architecture based on the plurality of AI-judge components, the first constitution, and the judgments of the one or more AI-judge architectures.

In some embodiments, said constructing the one or more AI-judge architectures using the plurality of AI-judge components and the one or more first principles of the first constitution comprises: generating data points from the first constitution; and injecting the data points into the one or more AI-judge architectures for verifying accuracy of the judgments thereof.

In some embodiments, said injecting the data points into the one or more AI-judge architectures for verifying the accuracy of the judgments thereof comprising: using a first FM, a prompt engineering technique, or a shared memory of a group of agents to inject the data points into the one or more AI-judge architectures for verifying accuracy of the judgments thereof.

In some embodiments, the computerized method further comprises: obtaining one or more first requirements and/or domain knowledge related to the context; and generating the one or more first principles based on the one or more first requirements and/or domain knowledge and a second constitution having one or more second principles.

In some embodiments, said generating the one or more first principles based on the one or more first requirements and/or domain knowledge and the second constitution comprises: generating, by a second FM, the one or more first principles based on the one or more first requirements and/or domain knowledge and the second constitution having the one or more second principles.

In some embodiments, the computerized method further comprises: converting a user prompt into one or more AI-judge requirements; transforming the one or more AI-judge requirements into the one or more second principles; identifying defects in the one or more second principles; and refining the one or more second principles in view of the identified defects.

In some embodiments, the converting, transforming, and refining steps are performed by using a third FM, and the identifying step is performed by a fourth FM.

In some embodiments, the computerized method further comprises: repeating the identifying and refining steps for one or more times.

In some embodiments, the computerized method further comprises: updating the second constitution using one or more third constitutions, the one or more third constitutions comprising the first constitution.

In some embodiments, said updating the second constitution using the one or more third constitutions comprises: identifying, by a fifth FM, one or more flaws in at least one of the one or more second principles of the second constitution; and updating, by the fifth FM, the identified at least one second principle using the one or more third constitutions.

In some embodiments, said updating the second constitution using the one or more third constitutions comprises: updating the second constitution based on user review.

According to one aspect of this disclosure, there is provided a system comprising: one or more non-transitory, computer-readable storage media; and one or more processors functionally connected to the one or more non-transitory, computer-readable storage media; wherein the one or more non-transitory, computer-readable storage media comprising computer-executable instructions; and wherein the instructions, when executed, cause the one or more processors to perform any of the above-described methods and/or any of the methods disclosed herein.

According to one aspect of this disclosure, there is provided an apparatus comprising one or more processors functionally connected to one or more memories storing instructions; the one or more processors are configured to execute the instructions to perform any of the above-described methods and/or any of the methods disclosed herein.

According to one aspect of this disclosure, there is provided one or more memories storing instructions; the instructions, when executed, cause one or more processors to perform any of the above-described methods and/or any of the methods disclosed herein.

In another aspect, embodiments of this disclosure provide an apparatus, wherein the apparatus comprises a function or unit to perform any of the above-described methods and/or any of the methods disclosed herein.

In another aspect, embodiments of this disclosure provide a computer readable storage medium, comprising one or more instructions, wherein when the one or more instructions are run on a computer, the computer performs any of the above-described methods and/or any of the methods disclosed herein.

In another aspect, embodiments of this disclosure provide a non-transitory computer-readable medium storing instruction the instructions causing a processor in a device to implement any of the above-described methods and/or any of the methods disclosed herein.

In another aspect, embodiments of this disclosure provide a device configured to perform any of the above-described methods and/or any of the methods disclosed herein.

In another aspect, embodiments of this disclosure provide a processor, configured to execute instructions to cause a device to perform any of the above-described methods and/or any of the methods disclosed herein.

In another aspect, embodiments of this disclosure provide an integrated circuit configure to perform any of the above-described methods and/or any of the methods disclosed herein.

According to one aspect of this disclosure, there is provided a module comprising: one or more circuits for performing any of the above-described methods and/or any of the methods disclosed herein.

According to one aspect of this disclosure, there is provided one or more processors functionally connected to one or more memories for performing any of the above-described methods and/or any of the methods disclosed herein.

According to one aspect of this disclosure, there is provided an apparatus comprising: one or more processors functionally connected to one or more memories for performing any of the above-described methods and/or any of the methods disclosed herein.

According to one aspect of this disclosure, there is provided an apparatus configured to perform any of the above-described methods and/or any of the methods disclosed herein.

In some embodiments the apparatus comprises one or more units configured to perform any of the above-described methods and/or any of the methods disclosed herein.

According to one aspect of this disclosure, there is provided one or more non-transitory, computer-readable storage media comprising computer-executable instructions, wherein the instructions, when executed, cause at least one processing unit, at least one processor, or at least one circuits to perform any of the above-described methods and/or any of the methods disclosed herein.

According to one aspect of this disclosure, there is provided one or more computer-readable storage media storing a computer program, wherein, when the computer program is executed by an apparatus, the apparatus is enabled to implement any of the above-described methods and/or any of the methods disclosed herein.

According to one aspect of this disclosure, there is provided a computer program product including one or more instructions, wherein, when the instructions are executed by an apparatus, the apparatus is enabled to implement any of the above-described methods and/or any of the methods disclosed herein.

According to one aspect of this disclosure, there is provided a computer program, wherein, when the computer program is executed by a computer, an apparatus is enabled to implement any of the above-described methods and/or any of the methods disclosed herein.

According to one aspect of this disclosure, there is provided a system comprising a node for performing any of the above-described methods and/or any of the methods disclosed herein.

According to one aspect of this disclosure, there is provided an apparatus for implementing any of the above-described methods and/or any of the methods disclosed herein in any possible implementation of the foregoing aspects.

In various embodiments, the above-described methods and/or the methods disclosed herein (denoted “AI-judge methods”) provide various benefits.

For example, the AI-judge methods provide semi-automation. More specifically, the AI-judge methods leverage FMs to generate general principles to reduce human effort on crafting the principles (for example, selecting eval metrics, crafting test datasets, and/or the like), and improve principle quality iteratively through several rounds of critique and revisions.

The AI-judge methods provide flexibility. More specifically, the AI-judge methods allow developers to accommodate any new feature changes in the target FMware that might emerge in the future by using the general constitution and the contextualized constitution.

The AI-judge methods provide task adaptation. More specifically, the AI-judge methods tailor the functionality to meet unique, context-specific tasks, improving its versatility across different applications and industries.

The AI-judge methods provide robustness. More specifically, the AI-judge methods use a robust feedback loop that refines the system's functionality, continuously improving its performance over time.

The AI-judge methods provide collaboration. More specifically, the AI-judge methods combine human expertise with FM capabilities in FMware evaluation and achieves a unified set of principles through agreement among multiple constitutions and humans.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM);

FIGS. 5A to 5C are schematic diagrams showing different types of the LLMs shown in FIG. 4, wherein

FIG. 5A is a schematic diagram showing an encoder-based LLM,

FIG. 5B is a schematic diagram showing a decoder-based LLM, and

FIG. 5C is a schematic diagram showing an encoder-decoder-based LLM;

FIGS. 6A to 6E are schematic diagrams showing common cognitive architectures for judging, wherein

FIG. 6A is a schematic diagram showing the cognitive architecture of reference-based judging,

FIG. 6B is a schematic diagram showing the cognitive architecture of reference-free judging,

FIG. 6C is a schematic diagram showing the cognitive architecture of pairwise judging,

FIG. 6D is a schematic diagram showing the cognitive architecture of ensemble judging,

FIG. 6E is a schematic diagram showing the cognitive architecture of deliberation judging;

FIG. 7 is a flowchart showing the operation of a search-driven constitution-based AI-judge method, according to some embodiments of this disclosure;

FIG. 8 is a schematic diagram showing an example of the search-driven constitution-based AI-judge method shown in FIG. 7, according to some embodiments of this disclosure.

### DETAILED DESCRIPTION

Embodiments disclosed herein relate to artificial intelligence (AI) judge systems employing a search-driven constitution-based framework, and apparatuses, methods, and non-transitory computer-readable storage media therefor. The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### A. System Structure

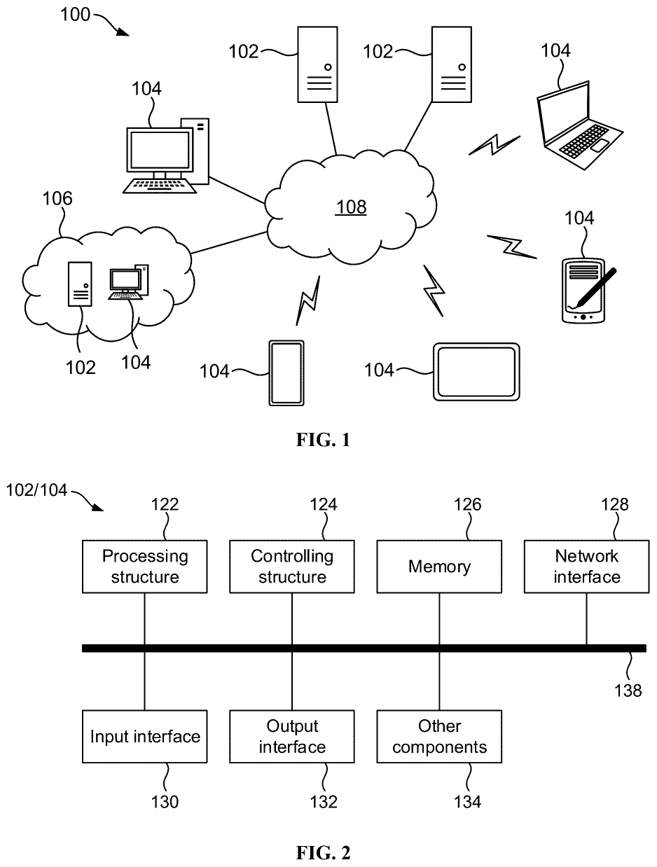

Turning now to FIG. 1, a computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

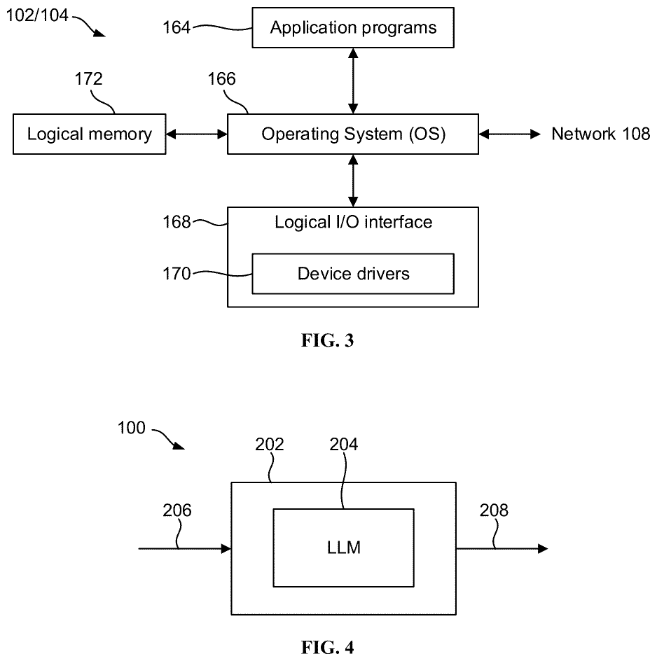

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Foundation Models and AI-Judge Systems

In some embodiments, the computer network system 100 executes an artificial intelligence (AI) engine (for example, in the form of one or more software programs). As shown in FIG. 4, the AI engine 202 comprises a foundation model (FM, such as a large language model (LLM) 204, which is used as an example in the following description) for processing input 206 (also called “prompt”; for example, natural language input in the form of text, voice, images, and/or the like), recognizing and interpreting the input 206 for generating the output 208 in suitable forms (for example, in form of text, image, audio, video, and/or the like) as the response to the prompt 206. As those skilled in the art will appreciate, FMs such as LLMs are neural network models that learn the semantics and syntax of language by encoding (sub)words into vector representations.

Using LLMs as an example, LLMs use transformer models and are trained using massive datasets. Current LLMs such as Chat-GPT, GPT-4, LLaMA, and PaLM2 have proven to achieve state-of-the-art (SOTA) performance in various natural language processing (NLP) tasks.

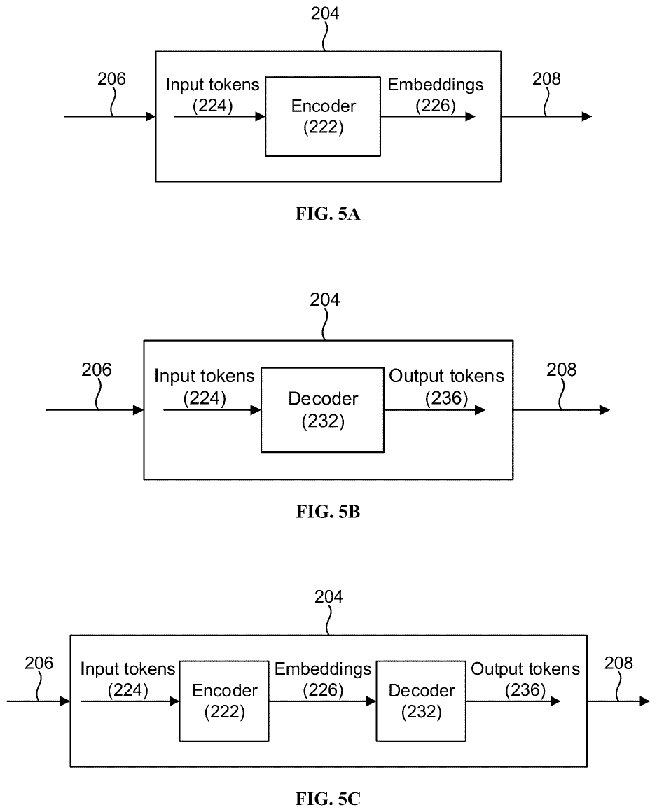

FIGS. 5A to 5C are schematic diagrams showing different types of LLM 204. These figures are simplified diagrams for showing the different types of LLM 204 only, and those skilled in the art will understand that the LLM 204 may also comprise other functional modules that are not shown in these figures.

FIG. 5A shows an encoder-based LLM 204 comprising an encoder 222 which processes the input tokens 224 (which are the units (for example, words or characters partitioned from the prompt 206) and generates embeddings 226 (which are then used to generate the output 208). As those skilled in the art understand, embeddings are high-dimensional vectors encoding semantic contexts and relationships of data tokens.

Most popular LLMs 204 are decoder-based (or “decoder-only”) models. As shown in FIG. 5B, the LLM 204 may be a LLM comprising a decoder 232 which processes the input tokens 224 and generates output tokens 236 (which are then used to generate the output 208). More specifically, the decoder-only LLM 204 learns to produce a distribution for the next token in a sequence given past context as input.

As shown in FIG. 5C, the LLM 204 may be an encoder-decoder-based LLM comprising an encoder 222 which processes the input tokens 224 and generates embeddings 226, and a decoder 232 which generates output tokens 236 based on the embeddings 226 (which are then used to generate the output 208).

LLMs have significantly improved the state-of-the-art on various NLP tasks. These models, powered by advanced techniques such as the generative pre-trained transformer (GPT) architecture, can learn the distribution of their training set well enough to generate realistic text.

As described above, the open-ended nature of the responses of LLMs (or more generally FMs) that are part of an FMware makes it difficult for developers to either manually evaluate all the responses, or craft a test dataset that includes all the possible responses of an FMware as oracles, and use the test dataset to measure the quality of the FMware. Therefore, practitioners have been developing AI judges or FM-based evaluators to reduce the manual evaluation effort for these FMware.

In prior art, OpenAI Evals provides a collection of pre-existing evals (that is, evaluators) to test various aspects, and allows users to create their own evals tailored to specific use cases. However, OpenAI Evals limits evaluations to OpenAI's models, and lacks support for custom evaluation metrics.

DeepChecks utilizes popular benchmarks (for example, Massive Multitask Language Understanding (MMLU) and Holistic Evaluation of Language Models (HELM)), ensuring standardized and reliable evaluation metrics. DeepChecks also offers a holistic approach to evaluating FMs, covering various aspects of performance, providing a thorough assessment. However, DeepChecks struggles to translate abstract requirements into measurable units, and is hard to navigate the intricacies of combing various evaluation metrics, benchmarks and FMs.

G-Eval developed by Liu et al. provides a framework of using FMs with chain of thought (CoT) to detailed evaluation steps. It focuses on text summarization and dialogue generation, and calculates the final score by probability-weighted summation. However, G-Eval faces difficulty in tracking the evaluation steps generated by CoT, has limited usage on the summarization and dialogue generation tasks, and requires manually effort on the creation and maintenance of prompts and eval criteria.

Prometheus developed by Kim et al. is an open-source FM built on top of Llama-2-Chat and Mistral-Instruct. It matches GPT-4's evaluation capabilities when using appropriate reference materials, fine-tunes the FM on a large dataset that consists of 100K feedback entries, and demonstrates a high Pearson correlation (0.897) with human evaluators. However, Prometheus requires significant computational resources for fine-tuning models for various judging tasks, set up evaluations in a complex, time-consuming manner that requires expertise, and faces difficulty in reusing the built models when FMware evolves.

LLM-as-a-judge/Chatbot Arena developed by Zheng et al. automates the evaluation process and conducts randomized battles in a crowdsourced manner. It handles large volumes of data efficiently, and is suitable for extensive evaluation tasks. However, it may fail to capture the nuances of human judgment, potentially leading to less accurate judgments, and has inherited weaknesses (for example, biases) from FMs and affect the fairness and objectivity of the judgments.

There are two key challenges in state-of-the-art AI-judge frameworks/ideas to effectively judge an FMware.

First, translating high-level requirements to measurable units is inherently challenging. Unlike conventional software applications, where judging requirements are often directly tied to specific functionalities or outputs, AI-judge systems for FMware must grapple with abstract concepts such as fairness, accuracy, and contextual understanding. These high-level requirements can be difficult to operationalize, leading to ambiguity in how an FMware should be evaluated. As a result, developers must engage in a complex iterative process to refine these requirements into quantifiable metrics. This involves not only extensive testing and calibration of the judging systems, but also a deep understanding of the underlying FMware that are intended to be assessed. The labor-intensive nature of this task can slow down the development process and impact the overall effectiveness of the AI-judge systems.

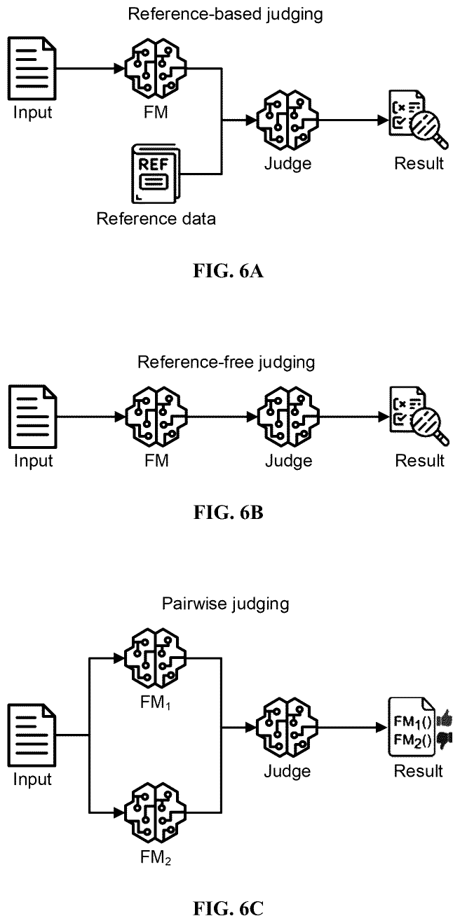

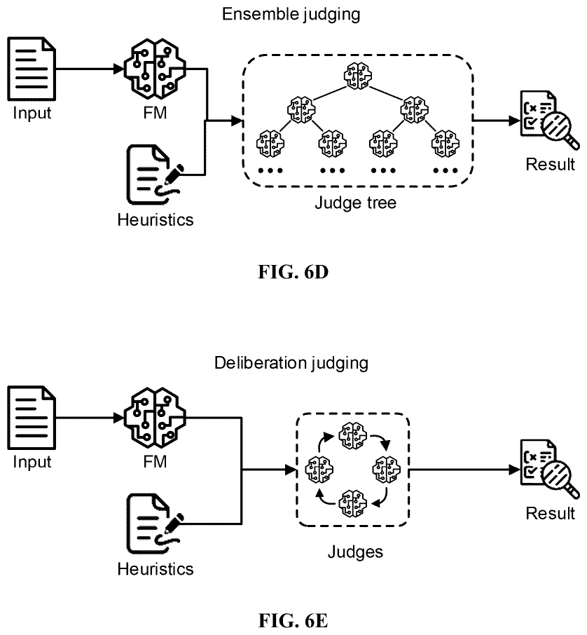

Second, developers must navigate the intricacies of developing AI-judge systems through a combination of cognitive architectures for evaluation and various jury FMs. FIGS. 6A to 6E are schematic diagrams showing common cognitive architectures for judging, including reference-based judging (FIG. 6A), reference-free judging (FIG. 6B), pairwise judging (FIG. 6C), ensemble judging (FIG. 6D), and deliberation judging (FIG. 6E). As can be seen, the cognitive architectures often include components such as jury FMs, judging heuristics, prompts and their relations, as well as metrics and their interactions, to make accurate judgments. There is no universally applicable judging architecture for all FMware. Each target FMware may require unique judging cognitive architectures tailored to its specific characteristics and objectives. This requires a flexible design that can incorporate diverse cognitive architectures, which may vary significantly in their methodologies and underlying assumptions. Furthermore, as the FMware field continues to evolve rapidly, AI-judge systems must be adaptive, continuously integrating new judging techniques into their judging architectures to keep pace with these changes. Such a dynamic environment often results in inconsistent judgments, particularly when a target FMware undergoes updates. As such, developers must maintain a balance between establishing robust judging architectures and ensuring that their AI-judge systems remain accurate to ongoing developments in the FMware landscape.

In some embodiments, a search-driven constitution-based framework AI-judge method (also denoted a “search-driven constitution-based AI-judge framework”) may be used, which transforms evaluation requirements into generic principles that are outlined in a constitution, so these principles may be reused over time and potentially be shared across AI-judge systems for similar FMware, that is, from a data-driven approach to a knowledge-driven approach. Herein, the term “principles” refer to any requirements/rules that are used for evaluating an FMware. The principles may vary from vague to detailed contexts. Herein, the term “constitution” refers to the ensemble of the principles. The principles outlined in a constitution may be grouped by certain scenarios.

The data-driven approach often exhibits inefficiencies in data utilization and lacks precise control mechanisms, while the knowledge-driven approach uses a graph-structured data model or topology (denoted a “knowledge graph”, which represents structured information about entities and their relationships, as well as unstructured text as node properties) to represent and operate on knowledge. Developers may further customize these principles to fit the specific needs of their FMware within their own specific context.

In some embodiments, the search-driven constitution-based AI-judge framework searches for the most appropriate required components (such as cognitive architectures, jury FMs and their interactions, and/or the like) to construct an AI-judge system. The constitution generates qualified data points to evaluate the AI-judge system, making it an iterative process that optimizes the AI-judge system.

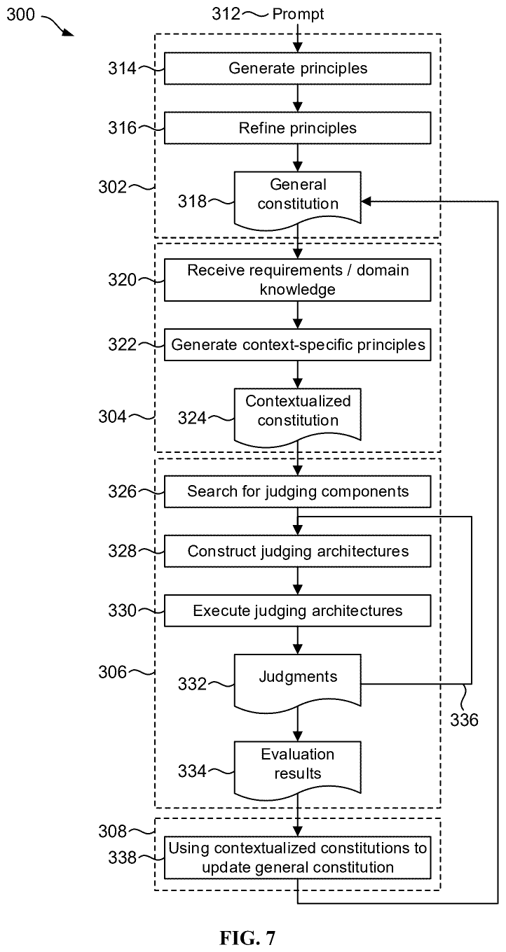

FIG. 7 is a flowchart showing the operation of a search-driven constitution-based AI-judge framework 300 for evaluating an FMware (such as and more particularly an FM of the FMware), according to some embodiments of this disclosure. In these embodiments, the search-driven constitution-based AI-judge framework 300 comprises four stages, including stage I (302) for creation of a general constitution, stage II (304) for specialization from the general constitution to a contextualized constitution, stage III (306) for searching for cognitive architectures using the contextualized constitution, and stage IV (308) for evolving the judge.

Stage I (302) starts when a prompt 312 is received from a user. In this stage, the search-driven constitution-based AI-judge framework 300 converts the prompt 312 (which may be the user's description of requirements for AI-judging) into one or more general AI-judge requirements, and transforms the one or more AI-judge requirements into one or more general principles (which are general and reusable guidelines that remain applicable, even when the target FMware evolves and when data and models drift over time) (step 314). The search-driven constitution-based AI-judge framework 300 then refines the one or more general principles for one or more times (step 316) to obtain a general constitution 318, which is used in stage II (304) for generating one or more contextualized constitutions.

In stage II (304), the search-driven constitution-based AI-judge framework 300 receives context-specific AI-judge requirements and/or domain knowledge from the user (step 320). Then, the search-driven constitution-based AI-judge framework 300 uses the received context-specific AI-judge requirements and/or domain knowledge to contextualize the general constitution 318 for generating context-specific principles and obtain a contextualized constitution 324 (which is the ensemble of the context-specific principles) (step 322). Steps in stage II (304) may be repeated for various contexts to generate various contextualized constitutions 324 therefor.

The generated contextualized constitutions 324 may be used in stage III (306) for evaluating FMwares. In stage III (306), based on the specification (that is, context) of a FMware, the search-driven constitution-based AI-judge framework 300 selects a contextualized constitution 324, and searches for an optimal combination of judging components such as judging architectures, jury FMs, and/or the like (step 326). The search-driven constitution-based AI-judge framework 300 then constructs one or more judging architectures for the specific FMware (step 328) using the combination of judging components and the contextualized constitution 324. The search-driven constitution-based AI-judge framework 300 then executes the one or more judging architectures for evaluating the FMware and obtaining one or more judgments 332. The obtained one or more judgments 332 are then assessed (for example, some may be rejected, and others may be combined) to obtain the evaluation results 334. Moreover, the obtained one or more judgments 332 may also be used as a feedback 336 to facilitate reconstruction of some or all of the judging architectures for improving the judging performance such as judging accuracy, and to refine and/or update the contextualized constitution 324 used in this stage.

In stage IV (308), the contextualized constitution 324 used in evaluating FMwares at stage III (306) may be used for updating the general constitution 318 (step 338).

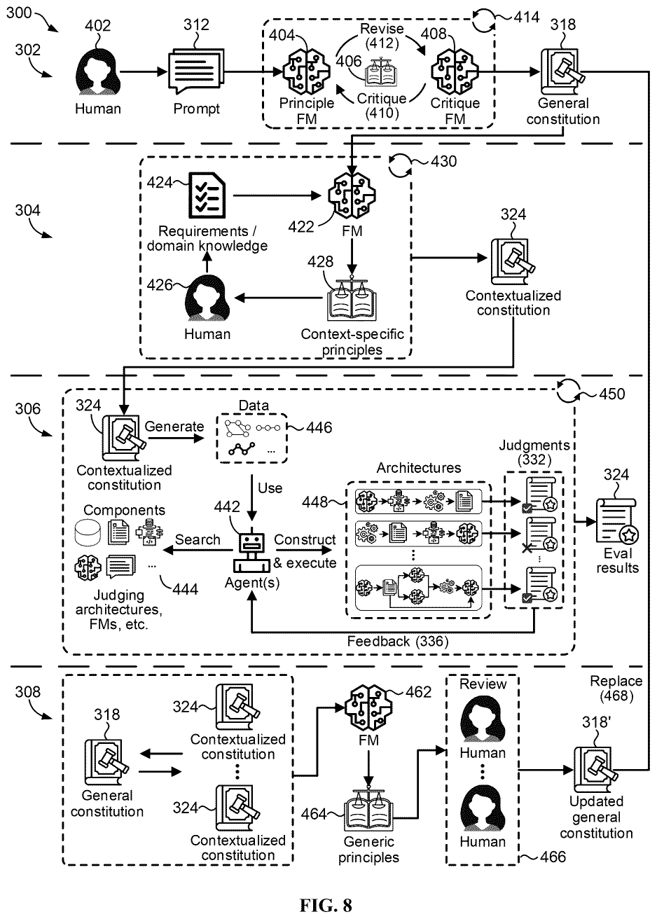

FIG. 8 is a schematic diagram showing a motivational example of the search-driven constitution-based AI-judge method, according to some embodiments of this disclosure. This example involves a commit message generation (CMG) task. The CMG task involves writing concise and descriptive commit messages for a given code diff in natural language. The commit messages are important for program comprehension and maintenance and collaboration among developers.

### Stage I (302): Creation of a General Constitution.

In this stage, a user 402 provides a prompt 312 (such as the user's description of requirements for AI-judging). The search-driven constitution-based AI-judge framework 300 uses a principle FM 404 to converts the prompt 312 into one or more AI-judge requirements (also denoted as 312), and transforms the one or more AI-judge requirements into one or more general principles 406 (which are general and reusable guidelines that remain applicable, even when the target FMware evolves and when data and models drift over time) (corresponding to step 314 shown in FIG. 7). The search-driven constitution-based AI-judge framework 300 also uses a critique FM 408 to identify defects or issues (such as unclear and/or ambiguous requirements) and provide “critiques” 410 (that is, the identified defects or issues) to the principle FM 404. The principle FM 404 then revises the requirements and subsequently the general principles (step 412). The critique/revise process may be performed one or more times (414) to refines the one or more general principles for one or more times (corresponding to step 316 shown in FIG. 7) to obtain one or more clear and concise principles, which forms a general constitution 318.

Thus, in stage I (302), the search-driven constitution-based AI-judge framework 300 or more specifically the principle FM 404 thereof transforms judging requirements 312 into criteria in a certain context. Such transformation in the search-driven constitution-based AI-judge framework 300 provides a consistent and scalable method for the ongoing evaluation and potential changes in the target FMware that developers of the AI-judge system may leverage when maintaining and updating the AI-judge system.

For example, developers may need to iteratively modify requirements until they arrive at a clear and concise version. Developers may initially come up with an ambiguous requirement such as “the commit message should be clear and concise to the changes made in a commit”, and expand it with more details such as “Use clear and descriptive language to convey the purpose of the commit. Avoid jargon and ambiguous terms to ensure that anyone reading the message can understand the changes made.”, before arriving at a concise version below:
“Be Descriptive and Specific:
   Clearly describe what the commit does, focusing on its impact within the codebase.
   Avoid vague messages like fixed bugs' or ‘updated code’.
   Avoid jargon that might not be universally understood.
   . . . ” (The rest is truncated)
      Stage II (304): Specialization from General to the Contextualized Constitution.

In this stage, the search-driven constitution-based AI-judge framework 300 uses a FM 422 to incorporate context-specific knowledge 424 (such as context-specific requirements and/or domain knowledge, which may be received from suitable sources such as a user 426 (such as a developer) at step 320 shown in FIG. 7) as a set of context-specific principles 428 (corresponding to step 322 shown in FIG. 7), and include the set of context-specific principles 428 into the general constitution 318 to form a contextualized constitution 324. The process in this stage 304 may involve collaboration between developers and the constitution to establish context-specific sets of principles, and may be performed one or more times (430) to obtain one or more contextualized constitutions 324 each for a particular context.

For example, one may define context-specific principles for writing commit messages for a given diff written in C++, along with its detailed criteria as follows:
“Mention C++ Standard or ABI Changes:
   If changes depend on specific C++ standards (e.g., C++17, C++20), mention the standard in the commit message.
   If ABI stability is impacted, such as when upgrading libraries or changing compilers, make this explicit.
   Message examples: Refactor ‘FileHandler’ to use ‘std::filesystem’ (requires C++17).”

A set of principles 428 specific to the context of this example may be developed in stage II (304), which are then combined with the general constitution 318 to form a contextualized constitution 324.

### Stage III (306): Searching for Cognitive Architectures Using the Contextualized Constitution.

In this stage, the search-driven constitution-based AI-judge framework 300 facilitates the development of AI-judge systems while ensuring the delivery of high-quality judgments through a search-based exploration. More specifically, based on the specification (that is, context) of a FMware, an agent 442 selects a contextualized constitution 324, and searches, from one or more suitable sources such as a database, for an optimal combination of AI-judge components 444 (such as judging architectures, jury FMs, and/or the like) (corresponding to step 326 shown in FIG. 7). The agent 442 then uses the combination of AI-judge components 444 to construct (step 328 shown in FIG. 7) and execute (step 330 shown in FIG. 7) one or more judging architectures 448, wherein data points 446 (that is, context-specific knowledge) generated from the selected contextualized constitution 324 are injected into the constructed one or more architectures 448 for verifying the accuracy of the judgments 332 generated by the one or more architectures 448. In various embodiments, the injection of context-specific knowledge into the constructed one or more architectures 448 may be achieved by using any suitable methods, such as by using a fine-tuned FM, by applying suitable prompt engineering techniques, by utilizing the (shared) memory of a group of agents, and/or the like.

The verification results may be feedback (336) to the agent 442, such that if the judgment of a constructed architecture 448 is inaccurate, the agent 442 then adapts by re-constructing a new architecture for replacing the inaccurate architecture. This iterative feedback loop 336 ensures that the agent 442 continuously learns from weaker areas and refines the constructed architecture 448.

The process in stage III (306) may be repeated (450), and eventually, the accurate judgments 332 are combined to obtain the evaluation results 324.

### Stage IV (308): Evolving the Judge

In stage IV (308), an FM 462 uses the contextualized constitutions 324 to update the general constitution 318. For example, the FM 462 may combine the context-specific principles 428 of the contextualized constitutions 324 and the general principles 406 of the general constitution 318 to obtain a set of generic principles 464 for forming an updated general constitution 318′ (which substitutes or replaces (468) the previous version 318 of the general constitution). In some embodiments, the set of generic principles 464 may be manually reviewed by one or more users 466 before forming the updated general constitution 318′.

In this stage 308, the search-driven constitution-based AI-judge framework 300 may address flaws in the general principles 406 outlined in the general constitution 318 of Stage I (302). Since these general principles 406 are derived from the judging requirements 312, any potential flaw may be traced back through the transformation obtained in Stage I (302) to ultimately reveal whether there is a bug in the original judging requirement 312, due to the knowledge-driven approach. For example, stage II (308) may involve identifying potential requirement bugs in the general constitution 318 through a semi-auto process among the general and contextualized constitutions 318 and 324 and the developers 466. Since the context-specific principles 428 that are outlined in the contextualized constitutions 324 have been manually reviewed and verified, the contextualized constitutions 324 may be used to automatically identify potential bugs or discrepancies in the general principles 406, instead of by the developers themselves manually.

The AI-judge system disclosed herein comprises several important components and stages to ensure accurate, context-aware, and adaptive evaluation across diverse judging tasks. In some embodiments, the system architecture is organized as follows:
Generic requirements generation (Stage I (302)):
   A general constitution 318 serves as the foundation, outlining general principles 406 that represent generic and reusable requirements 312 applicable across various AI-judge systems. These principles 406 may be shared and adapted to different contexts when evaluating similar FMware. Users 402 specify requirements 312 through NLP, with or without supplementary information such as existing documentation or test data.
   FM 404 assists in refining and breaking down these requirements 312 into detailed evaluation units (such as criteria, metrics, score rubrics, and/or the like). This ensures comprehensive coverage and high-quality requirements are obtained and ensure the accuracy of the judgments made by the AI-judge system. In various embodiments, the FM 404 may be used with or without prompt engineering techniques. As those skilled in the art understand, prompt engineering techniques are methods for generating effective natural language prompts for AI models such as LLMs, to facilitate the AI models to generate high-quality outputs. Examples prompt engineering techniques include zero-shot prompting, few-shot prompting, chain of thought (CoT) prompting, meta prompting, prompt chaining, role prompting, contextual prompting, template filling, graph prompting, and the like.
Context-specific knowledge specification (Stage II (304)):
   A method for integrating context-specific knowledge into the cognitive architecture of the AI-judge system, enabling dynamic customization and adaptation of system responses and behavior based on external inputs or task-specific requirements.
   This process is collaborative, involving FMs and, in some embodiments, human inputs, and may incorporate prompt engineering techniques. The specification (that is, requirements and consequently the principles) is refined through an iterative process of critiques, revisions, and enhancements, ensuring precise and relevant customization.
Context-specific knowledge injection (Stage II (304)): A mechanism for injecting context-specific knowledge into the cognitive architecture, allowing it to tailor its performance to context-specific judging tasks. This injection can be achieved through various methods, including fine-tuned FMs, applying prompt engineering techniques, or utilizing the (shared) memory of a group of agents.
Autonomous exploration and mitigation (Stage III (306)): An autonomous exploration mechanism is employed to evaluate and construct the most suitable judging architectures. This mechanism verifies configurations, identifies potential errors within certain judging components (for example, biases in FMs, prompt instability, and/or the like), and mitigates these errors to ensure consistent, high-quality evaluation outputs across a range of tasks and contexts.
Self-optimizing search architecture (Stage III (306)):
   The system incorporates an intelligent, self-optimizing architecture that enables agents 442 to access and utilize essential components 444 for constructing the AI-judge system. It learns from previous failures recorded in historical data, allowing for iterative improvements.
   This architecture features a search-driven optimization process that autonomously refines and updates system configurations through feedback loops 336, ensuring continuous adaptability and alignment with changing requirements.
Constitution-governed self-evolution (Stage IV (308)):
   The system employs an adaptive update protocol that governs its evolution based on principles 406 outlined in the general constitution 318. This protocol updates and refines these principles 406, integrating qualified and verified principles 428 from contextualized constitutions 324 within specific judging scenarios.
   This self-evolving mechanism maintains data integrity, security, and ongoing compliance with user-defined standards, ensuring the AI-judge system remains robust and reliable over time.
Flexible human intervention control (Stage I, II, and IV (302, 304, and 308)):
   A user-controlled interface offers customizable levels of human interaction within the AI-judge system, allowing users 402, 426, and 466 (which may be the same or different users in various embodiments) to choose the degree of oversight and manual adjustment based on their needs.
   This flexibility ranges from complete control over system operations to minimal, autonomous functionality. The interface, together with other suitable techniques such as grid search, evolutionary algorithms, and/or the like, may facilitate the simplification of configuration settings and make it easier for users to manage and control the system's processes.

In some embodiments, the AI-judge system may be implemented using a multi-agent collaborative architecture, where multiple agents (for example, each powered by one or more FMs) work together to provide a more comprehensive and balanced evaluation process.
Collaborative decision-making agents: The system integrates multiple specialized agents, each responsible for different aspects of the judgment process. These agents may include roles such as fact-checking, context analysis, bias detection, contextual interpretation, and/or the like. Each agent contributes analysis and feedback, creating a collaborative decision-making process. This collaboration ensures a more nuanced and accurate judgment, where outputs from each agent are synthesized to form a final, well-rounded decision.
Task-specific agent roles: Agents can be assigned specific roles based on the context-specific principles (requirements) of the judging task. For example, one agent may focus on checking the factual accuracy of information, while another may handle tone and language analysis. This role-based configuration allows for parallel processing, where each agent specializes in a particular aspect of the evaluation, leading to faster and more reliable judgments.
Autonomous agent coordination and consensus building: The system features a mechanism for autonomous coordination among agents, ensuring they can communicate and share insights effectively. A consensus-building algorithm is employed to synthesize the diverse inputs from different agents, weighting their outputs based on the relevance and confidence of each agent's findings. This results in a final decision that reflects a balanced perspective, minimizing the risk of errors and biases.
Agent memory and knowledge sharing: Agents have access to a shared memory architecture that manage the exchange of relevant data, context, and insights. This shared memory can be updated when new information is introduced, ensuring that agents can learn from past evaluations and refine their judgments over time. Knowledge sharing also facilitates the adaptation of agents to new judging tasks, as they can draw on collective insights and apply them in different contexts.

The AI-judge system and methods disclosed herein provide several advantages.

For example, the AI-judge system and methods disclosed herein provide semi-automation.

More specifically, the AI-judge system and methods disclosed herein leverage FMs to generate general principles to reduce human effort on crafting the principles (for example, selecting eval metrics, crafting test datasets, and/or the like), and improve principle quality iteratively through several rounds of critique and revisions.

The AI-judge system and methods disclosed herein provide flexibility. More specifically, the AI-judge system and methods disclosed herein allow developers to accommodate any new feature changes in the target FMware that might emerge in the future by using the general constitution and the contextualized constitution.

The AI-judge system and methods disclosed herein provide task adaptation. More specifically, the AI-judge system and methods disclosed herein tailor the functionality to meet unique, context-specific tasks, improving its versatility across different applications and industries.

The AI-judge system and methods disclosed herein provide robustness. More specifically, the AI-judge system and methods disclosed herein use a robust feedback loop that refines the system's functionality, continuously improving its performance over time.

The AI-judge system and methods disclosed herein provide collaboration. More specifically, the AI-judge system and methods disclosed herein combine human expertise with FM capabilities in FMware evaluation and achieves a unified set of principles through agreement among multiple constitutions and humans.

In some embodiments, the AI-judge system and methods disclosed herein may be implemented in any product or service that involves evaluating FMware, such as cloud service providers and platform engineering products.

The AI-judge system and methods disclosed herein are flexible to be used to evaluate FMware in any type of software domains that already exist or might appear in the future, for example:

### Alternative Optimization Techniques:

For example, in some embodiments, the search-driven optimization may be replaced with other machine learning techniques such as reinforcement learning, genetic algorithms, and/or the like, to achieve self-optimizing architectures. By using alternative strategies, the AI-judge system may also achieve the adaptive and self-refining nature.

### Different Knowledge Injection Approaches:

Instead of using context-specific knowledge injection through fine-tuning or prompt engineering, the AI-judge system in some embodiments may use knowledge graphs, rule-based systems, ontologies, rule-based algorithms, and/or the like, to achieve customization. These approaches may provide the adaptability of injecting context-specific knowledge without relying on the same FM strategies.

### Modular and Plug-and-Play Architectures:

In some embodiments, the AI-judge system may comprise modular components that may be swapped out easily, allowing for context-specific customization without following the exact iterative refinement approach. By creating an ecosystem of interchangeable modules, the AI-judge system may offer flexibility to context-specific knowledge customization.

### Manual Override Interfaces for Adaptable Control:

In some embodiments, the AI-judge system may comprise interfaces that allow users to apply manual overrides to control system operations, similar to the flexible human intervention control described above. This may be achieved by providing different levels of interaction but avoiding the direct methods of configurability and simplification outlined in the interface.

### C. Acronyms, Abbreviations, and Definition of Some Terms

| Full Name | Acronym/Abbreviation/Initialism |
|---|---|
| Software Engineering | SE |
| Foundation Model | FM |
| Large Language Model | LLM |
| Chain of Thought | CoT |

Some technical terms are defined as follows:
Foundation Model (FM): A machine learning model trained in a large scale and generalist dataset and that can be adapted to perform a wide range of specialized downstream tasks.
Large Language Model (LLM): A subset of Foundation Models, specifically focused on understanding and generating human language, trained on extensive text data to excel at language-related tasks such as translation, summarization, and conversation.
Foundation Model powered software (FMware): Software applications that use FMs as one of its building blocks (for example, ChatGPT).
Prompt Engineering: A technique used in the field of artificial intelligence to design specific inputs, known as prompts, that guide the outputs of FMs. By carefully crafting these prompts, users can effectively control the responses generated by the FMs, optimizing its performance for various applications. This technique leverages the inherent capabilities of FMs to understand and generate human language by providing well-structured and contextually relevant prompts.
Chain of Thought (CoT): A cognitive process where reasoning steps are explicitly broken down to solve a problem or make a decision and ensure the accuracy. It is one of the prompt engineering techniques.
Agent: An agent or agentic system refers to an autonomous AI entity that leverages the capabilities of FMs to perform specific tasks based on user inputs. These agents utilize advanced natural language processing and understanding techniques to interact with users, comprehend their requests, and execute appropriate actions. The term “agentic” highlights the system's ability to act independently and make decisions, often integrating reasoning and contextual analysis to optimize task performance across various applications.
Constitutions and principles: The principles refer to any requirements/rules that are used for evaluating an FMware. The principles vary from vague to detailed contexts. The principles outlined in a constitution are grouped by certain scenarios.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Although in above examples, the adaptive information retrieval method is performed by the computer network system 100, in some embodiments, no computer network system 100 is required, and the methods disclosed herein is performed by a single computing device 102 or 104.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method for judging a foundation model (FM) powered software, the method comprising:
searching for a plurality of AI-judge components;
constructing one or more AI-judge architectures based on the plurality of AI-judge components and a first constitution, the first constitution comprising one or more first principles each representing a requirement or rule adapted to a context related to the FMware; and
executing the one or more AI-judge architectures to generate judgments for judging the FM-powered software.

2. The computerized method of claim 1 further comprising:
determining that the judgment of at least one AI-judge architecture of the one or more AI-judge architectures is inaccurate; and
reconstructing the determined at least one AI-judge architecture based on the plurality of AI-judge components, the first constitution, and the judgments of the one or more AI-judge architectures.

3. The computerized method of claim 1, wherein said constructing the one or more AI-judge architectures using the plurality of AI-judge components and the one or more first principles of the first constitution comprises:
generating data points from the first constitution; and
injecting the data points into the one or more AI-judge architectures for verifying accuracy of the judgments thereof.

4. The computerized method of claim 1 further comprising:
obtaining one or more first requirements and/or domain knowledge related to the context; and
generating the one or more first principles based on the one or more first requirements and/or domain knowledge and a second constitution having one or more second principles.

5. The computerized method of claim 1 further comprising:
converting a user prompt into one or more AI-judge requirements;
transforming the one or more AI-judge requirements into the one or more second principles;
identifying defects in the one or more second principles; and
refining the one or more second principles in view of the identified defects.

6. The computerized method of claim 4 further comprising:
updating the second constitution using one or more third constitutions, the one or more third constitutions comprising the first constitution.

7. A system comprising:
one or more non-transitory, computer-readable storage media; and
one or more processors functionally connected to the one or more non-transitory, computer-readable storage media;
wherein the one or more non-transitory, computer-readable storage media comprising computer-executable instructions; and
wherein the instructions, when executed, cause the one or more processors to perform the method of claim 1.

8. The system of claim 7 further comprising:
determining that the judgment of at least one AI-judge architecture of the one or more AI-judge architectures is inaccurate; and
reconstructing the determined at least one AI-judge architecture based on the plurality of AI-judge components, the first constitution, and the judgments of the one or more AI-judge architectures.

9. The system of claim 7, wherein said constructing the one or more AI-judge architectures using the plurality of AI-judge components and the one or more first principles of the first constitution comprises:
generating data points from the first constitution; and
injecting the data points into the one or more AI-judge architectures for verifying accuracy of the judgments thereof.

10. The system of claim 7 further comprising:
obtaining one or more first requirements and/or domain knowledge related to the context; and
generating the one or more first principles based on the one or more first requirements and/or domain knowledge and a second constitution having one or more second principles.

11. The system of claim 7 further comprising:
converting a user prompt into one or more AI-judge requirements;
transforming the one or more AI-judge requirements into the one or more second principles;
identifying defects in the one or more second principles; and
refining the one or more second principles in view of the identified defects.

12. The system of claim 10 further comprising:
updating the second constitution using one or more third constitutions, the one or more third constitutions comprising the first constitution.

13. One or more non-transitory, computer-readable storage media comprising computer-executable instructions, wherein the instructions, when executed, cause one or more processors to perform the method of claim 1.

14. The one or more non-transitory, computer-readable storage media of claim 13 further comprising:
determining that the judgment of at least one AI-judge architecture of the one or more AI-judge architectures is inaccurate; and
reconstructing the determined at least one AI-judge architecture based on the plurality of AI-judge components, the first constitution, and the judgments of the one or more AI-judge architectures.

15. The one or more non-transitory, computer-readable storage media of claim 13, wherein said constructing the one or more AI-judge architectures using the plurality of AI-judge components and the one or more first principles of the first constitution comprises:
generating data points from the first constitution; and
injecting the data points into the one or more AI-judge architectures for verifying accuracy of the judgments thereof.

16. The one or more non-transitory, computer-readable storage media of claim 15, wherein said injecting the data points into the one or more AI-judge architectures for verifying the accuracy of the judgments thereof comprising:
using a first FM, a prompt engineering technique, or a shared memory of a group of agents to inject the data points into the one or more AI-judge architectures for verifying accuracy of the judgments thereof.

17. The one or more non-transitory, computer-readable storage media of claim 13 further comprising:
obtaining one or more first requirements and/or domain knowledge related to the context; and
generating the one or more first principles based on the one or more first requirements and/or domain knowledge and a second constitution having one or more second principles.

18. The one or more non-transitory, computer-readable storage media of claim 13 further comprising:
converting a user prompt into one or more AI-judge requirements;
transforming the one or more AI-judge requirements into the one or more second principles;
identifying defects in the one or more second principles; and
refining the one or more second principles in view of the identified defects.

19. The one or more non-transitory, computer-readable storage media of claim 17 further comprising:
updating the second constitution using one or more third constitutions, the one or more third constitutions comprising the first constitution.

20. The one or more non-transitory, computer-readable storage media of claim 19, wherein said updating the second constitution using the one or more third constitutions comprises:
identifying, by a fifth FM, one or more flaws in at least one of the one or more second principles of the second constitution; and
updating, by the fifth FM, the identified at least one second principle using the one or more third constitutions.
